(19) United States
(12) Patent Application Publication
(10) Pub. No.: US 2015/0367433 A1
(43) Pub. Date: Dec. 24, 2015

(54) SAW BLADE HAVING INTEGRATED SWARF SPACE

(71) Applicant: ALBERT KNEBEL GMBH & CO. KG HOLDING, Balingen (DE)

(72) Inventor: ALEXANDER KNEBEL, BALINGEN (DE)

(73) Assignee: Albert Knebel GMBH & Co. KG Holding, Balingen (DE)

(21) Appl. No.: 14/763,939

(22) PCT Filed: Aug. 7, 2013
(86) PCT No.: PCT/EP2013/066519

§ 371 Date: Jul. 28, 2015

(30) Foreign Application Priority Data
Jan. 28, 2013 (DE) 10 2013 201 291.8

(51) Int. Cl. B23D 61/02

(52) U.S. Cl. CPC B23D 61/025; B23D 61/021

(57) ABSTRACT

A saw blade having a saw blade body and a plurality of regularly or irregularly distributed cutting teeth is formed with a tooth-bearing region below the cutting teeth. In the tooth-bearing region, a (3) the thickness of the saw blade body is reduced compared with a remainder of the saw blade body. Also, edges Tat boundary sides provided with bevels to assist in an improved removal of swarf and directing of swarf.

The invention relates to a saw blade having a saw blade body and a plurality of cutting teeth distributed regularly or irregularly along a tooth-bearing region of the saw blade.

Circular saw blades and endless saw blades have been known fundamentally for a long time. Saw blades having widely varying cutting tooth shapes and cutting edges installed on the teeth are known. A swarf space by means of which swarf generated is received and removed is conventionally located below a cutting tooth. Blocking of the saw blade during operation is thereby to be prevented.

The problem with known saw blades is that the cutting teeth are not very rigid and because of the formation of air vortices noise which is undesirable arises. Furthermore, a grooved cut surface which is not clean arises due to axial vibrations.

The object of the present invention is to provide a saw blade which has improvements in this respect.

This object is achieved according to the invention by a saw blade having a saw blade body and a plurality of cutting teeth distributed regularly or irregularly along a tooth-bearing region of the saw blade, wherein in the tooth-bearing region below the cutting teeth the thickness of the saw blade body is reduced compared with the remainder of the saw blade body and wherein the tooth-bearing region of reduced thickness serves as a swarf space. This means that the shape of the teeth can be kept very flat and low. No swarf space in the sense of a free space or opening, as is conventional with known circular saw blade configurations, is present or necessary below the cutting tooth. This results in a very rigid tooth and due to the closed form a low-noise running of the saw blade, since a formation of air vortices of the saw blade, in particular rotating saw blade, causing noise is reduced considerably. The saw blade can be constructed as a circular saw blade or endless saw blade. In the case of a circular saw blade the tooth-bearing region is a circumferential region and the teeth are distributed over the circumference of the circular saw blade.

The tooth-bearing region of reduced thickness receives the swarf material produced by the cutting teeth positioned directly above, so that a swarf space divided into two is present in this embodiment: in one case the space behind the tooth back, as with conventional saw blades, and furthermore the space present below the tooth in the region of the thickness reduction. The saw blade according to the invention results in the additional advantage of a considerably quieter running noise, especially during idling, due to the formation of air vortices being largely avoided. In the case of a circular saw blade in particular an automatic limitation in swarf thickness results due to the largely closed circumferential contour of the saw blade. An unwanted drawing of the tool into the cut is thereby avoided. It is therefore also suitable for manual advancing.

A significantly reduced so-called multiple machining of the swarf occurs, since immediately after cutting the swarf is led away from the contact region of the cutting edge into the indented region (of reduced thickness) lying underneath. The reduced contact between the cutting edges and swarf material has the effect of a reduced exposure to wear of the cutting edges and therefore an improved service life.

Because of the short, rigid cutting tooth shape, a very good cutting quality results. Typical grooving on the workpiece surfaces is reduced considerably due to the configuration of the saw body, which represents a further advantage of the present saw blade embodiment.

Cutting edges can be installed on the cutting teeth, it being possible for the cutting edges to be provided with a cutting material which is harder than the saw blade body. The cutting material can be made of hard metal, polycrystalline diamond (PCD), hardened steel, stellite or another suitable hard material.

Preferably, a cutting material such as PCD (polycrystalline diamond) is employed, since no grinding has to be carried out on the tooth front face (cutting face) in this case.

The cutting material can be joined to the saw blade body, in particular the cutting teeth, by soldering, gluing, welding or by means of another suitable process. The cutting material and a circular region on the saw blade circumference, in particular the region of reduced thickness, can additionally be provided with a coating of hard material. This coating can be configured as a monolayer, multilayer, gradient coating, composite structure or in another suitable manner.

In this context a monolayer is understood as meaning a coating which comprises one coating layer. Accordingly, a multilayer is understood as meaning a coating of several layers of one and the same coating material or of several layers of different coating materials, also applied alternately. A gradient coating is understood as meaning coating with coating material comprising at least two different components, the mixing ratio or the contents of the individual components varying continuously and steadily within the coating thickness. A composite structure is understood as meaning a coating having as a rule a grid-like supporting structure in the atomic or molecular region and one or more further components embedded in this structure.

The cutting edges can have any desired geometry.

Preferably, the saw blade is designed in a so-called thin-cutting configuration. Saw blades in a thin-cutting configuration have a width of cut which is narrow (thin) in relation to the diameter and a relatively thin saw blade body. On the basis of this property a saving in energy occurs due to a narrow width of cut and as a result a lower driving power requirement. Less scrap/less swarf waste moreover arises due to a smaller width of cut. This leads to a saving in material.

Compared with saw blades in the conventional configuration (i.e. with a conventional configuration of the swarf space), the saw blades according to the invention can be thinner in configuration, i.e. have a smaller width of cut.

The saw blade according to the invention can be designed as a disposable saw blade without the possibility of resharpening, or alternatively as a saw blade which is suitable for resharpening.

According to a particularly preferred embodiment the saw blade body can have on one side or on both sides, at least in sections, an indentation which in particular is circular, so that the saw blade body has a lower thickness in this region. The indentation, which in particular is circular, can also be continuous in construction. In other words, this means that the saw blade body has in the region of its circumference or tooth-bearing region at least in one section on at least one side a type of stage in which the saw blade body is reduced in thickness.

Alternatively or additionally, the saw blade body can have at least in sections below the cutting teeth on one side or on both sides individual pockets, so that the saw blade body has a smaller thickness in the region of the pockets. The saw blade body can thus have on one or on both sides in the tooth-bearing region one or more recesses. The recess can be continuous, in particular circular, at least in sections, or pocket-like recesses can be provided at least in sections. It is also conceivable to provide exclusively pocket-like recesses or to provide exclusively a continuous, in particular circular indentation. It is also conceivable to provide on one side of the saw blade recesses constructed as pockets and to provide on the opposite side of the saw blade a continuous indentation.

The width of the tooth-bearing region of reduced thickness can be up to one third of the saw blade diameter, but preferably the width of the indented region (of reduced thickness) is 5 to 10% of the diameter value of circular saw blades. This ensures that the saw blade has an adequate stability.

According to one embodiment of the invention, the thickness of the saw blade body in the tooth-bearing region can be greater than one third of the thickness of the saw blade body outside the tooth-bearing region. In particular, on each side of the saw blade the recess of the saw blade body can be at the most one third of the saw blade thickness. The depth of the tooth-bearing region or of the recess of the saw blade body can be the same on both sides or can be of different depth. In particular it is conceivable to provide a recess in the tooth-bearing region only on one side of the saw blade. Preferably, however, the saw blade body has a recess in a tooth-bearing region on two sides, i.e. on both sides. The recess in this context, however, is merely a thickness reduction. As a rule no slits or continuous holes should be present in the tooth-bearing region.

In the tooth-bearing region of reduced thickness of the saw blade body areas can be provided which are inclined with respect to a saw blade centre plane. In particular, the recesses incorporated as a swarf space below the cutting teeth can be configured as recesses which are continuous on both sides, in particular annular, or as individual pockets also with areas inclined with respect to the saw blade centre plane. In the case of inclined areas the tooth-bearing region can thus be configured with a decreasing or conversely with an increasing thickness of the saw blade body towards the saw blade centre. The inclined areas preferably start below a roof-like chamfer or bevel which is constructed on the outermost saw blade boundary or circumference and is still to be explained later.

It is furthermore conceivable that in the tooth-bearing region of reduced thickness of the saw blade body areas are provided which are aligned parallel to a saw blade centre plane. A combination of inclined and parallel areas is also conceivable. In particular, the circumferential region can be composed of inclined area portions and area portions running parallel to the saw blade plane.

The areas on opposite sides with respect to a saw blade centre plane can be configured asymmetrically with respect to the saw blade centre plane. In the case of completely or partially inclined areas in particular, the width and depth of these recesses in the tooth-bearing region of the saw blade body can be configured in a different width or different depth on one side or on both sides, i.e. asymmetrically to the saw blade centre plane.

According to a preferred embodiment, chamfers or bevels can be provided on the boundary or circumference of the saw blade. In particular, bevels or chamfers can be provided on the cutting teeth, in particular the backs of the cutting teeth. The bevels or chamfers can be provided in particular in a roof-like manner, i.e. on both sides. In particular, the cutting edges and/or the outermost boundary or circumference of the saw blade body can be shaped by chamfers or bevels such that the swarf produced is divided during sawing and is guided on both sides below the cutting edges in the tooth-bearing region of reduced thickness, from where the swarf then is spun away from the saw blade in the conventional manner on discharge from the workpiece contour, in particular by the action of centrifugal force. By providing bevels on edges in the circumferential or boundary region the directing of swarf and removal of swarf can thus be assisted.

The chamfers or bevels can extend in continuous line or area courses into the saw blade body, so that the saw blade body can likewise have roof-like areas or bevels on the outer boundary or circumference behind the cutting edges.

The chamfers or bevels can extend into the region of reduced thickness. However, it is also conceivable that the chamfers or bevels extend into the region which is not of reduced thickness.

Further advantages result if a chamfer or bevel provided in the outer circumference or the boundary of the saw blade extends to behind a cutting edge of the next cutting tooth, also in the case of the optional presence of a notch in the tooth back. In particular, the chamfer or bevel can be guided such that the areas which are thereby formed on both sides and are inclined towards the saw blade centre first exit behind the front face of the following cutting edge. These areas chamfered in a roof-like manner are suitably installed by grinding before the saw blade body is equipped with cutting edges. By this configuration directing of the swarf volume downwards out of the region of the cutting edges, e.g. towards the saw blade centre, is achieved without the swarf material backing up at the lower end of the swarf area.

A further advantage also results by the use of cooling lubricants, the swarf fly thereby being slowed down and the transporting away into the regions of laterally reduced thickness (swarf space areas) being promoted.

Cutting edges can be arranged on the cutting teeth, the lateral cutting edge overhang being more than 0 mm and up to 1.0 mm with respect to the saw blade body which is not reduced in thickness. Blocking of the saw blade in the cut gap can thereby be avoided.

The saw blade body can be configured as a closed area, i.e. without so-called expansion slots on the saw blade circumference, and without damping ornaments within the saw blade body. However, it is also conceivable to provide expansion slots and ornaments or also only expansion slots or only ornaments as a special form.

If expansion slots and/or ornaments are present these are preferably incorporated by means of laser cutting and can be configured with or without filling with a suitable elastic, expandable material.

The outer circumference or the boundary of the saw blade can have notch, in particular u- or v-shaped notch. Such an embodiment can be advantageous for production reasons. The notch can be, in particular, a discharge zone of an eroding tool or of a grinding disc during finishing of the fixed, e.g. soldered-in or glued-in, cutting edge on the outer circumference(=tooth back region).

According to a further embodiment the front faces of the cutting teeth or cutting edges can have an axial angle β in the range of 0<β<45°. This means that the front faces of the cutting teeth or cutting edges, i.e. the sides of the cutting teeth or cutting edges facing forwards in the direction of movement of the saw blade, can deviate from a right-angle position with respect to the saw blade centre plane to an inclination to the left or right. This arrangement is known as a so-called axial angle. The angle between the front face of the cutting teeth or cutting edge and a perpendicular to the saw blade centre plane is preferably between 0 and 45°. The alignment of the front faces here can be directed alternately to the left and right or can be configured such that all the front faces are inclined only to the left or only to the right. However, any desired combinations of front faces inclined to the left, inclined to the right and not inclined to one side are also conceivable.

The saw blade body can have a hollow directly before at least one cutting tooth or at least one cutting edge. This means that the saw blade can have a height- or circumference-reducing hollow directly before at least one cutting tooth or directly before at least one cutting edge. This hollow or recess can serve as a feeding space for the swarf arising at the cutting edge or front face of the cutting edge or cutting tooth into the lateral thickness reductions of the saw blade body which are installed below the cutting teeth and which according to the invention serve as an integrated swarf space for receiving and for transporting away the swarf. The shape of the feeding space, i.e. the recess or hollow, can be approximately semicircular, approximately u-shaped or approximately v-shaped in construction.

Further features and advantages of the invention emerge from the following description of an embodiment of the invention.

The drawings show:

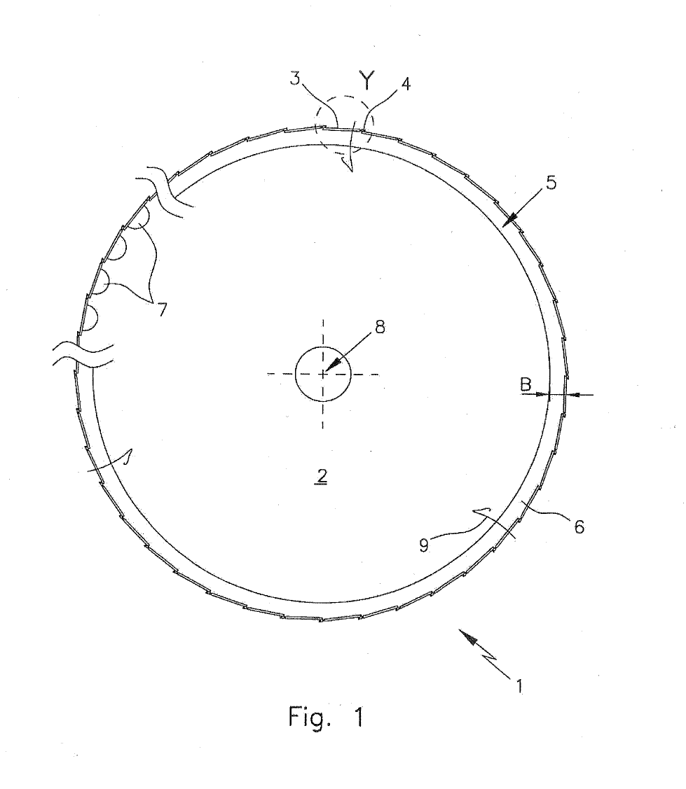

FIG. 1 a plan view of a circular saw blade;

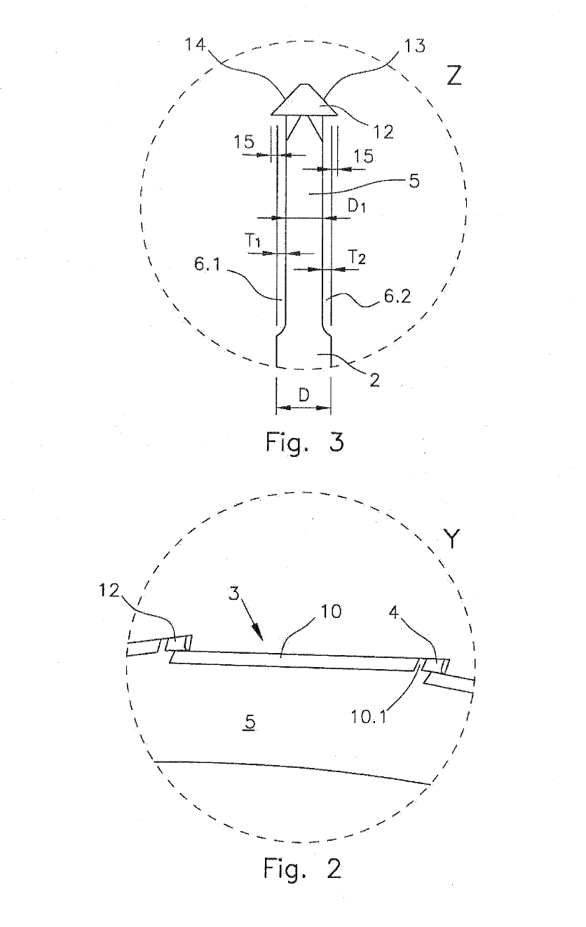

FIG. 2 an enlarged diagram in the region of the circumference of the circular saw blade;

FIG. 3 a section diagram through the boundary region of the circular saw blade;

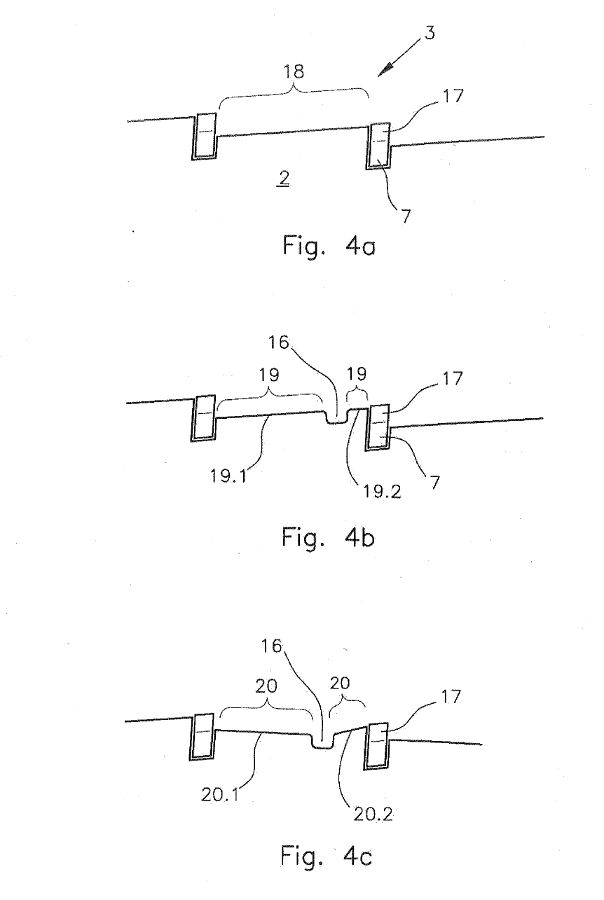

FIG. 4a an enlarged diagram in the region of the circumference of the circular saw blade to illustrate incorporated pockets;

FIG. 4b an enlarged diagram in the region of the circumference of the circular saw blade to illustrate a particular configuration of a tooth back region;

FIG. 4c a variant of the embodiment according to FIG. 4b;

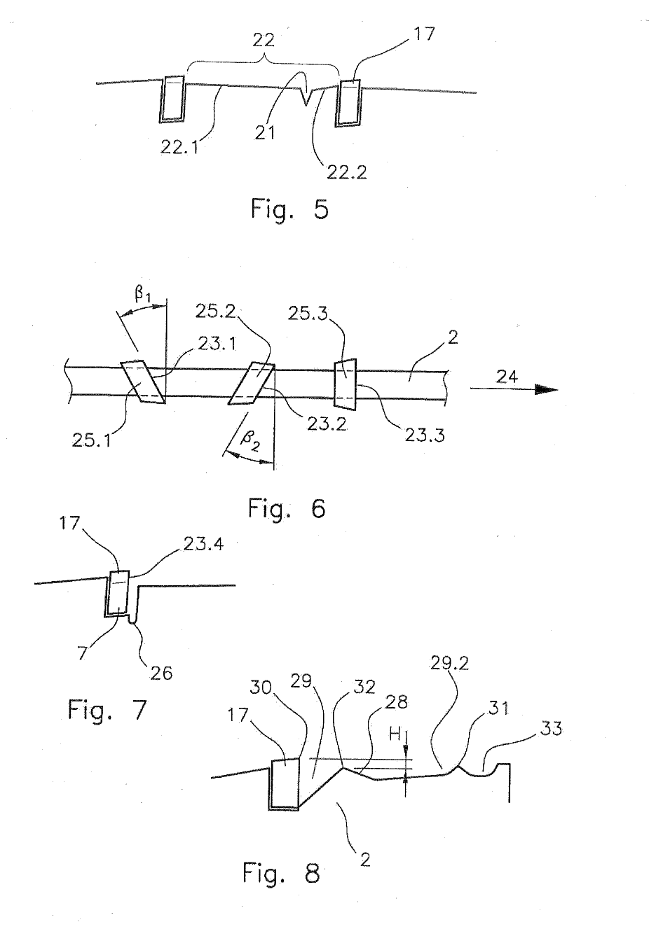

FIG. 5 an enlarged diagram in the region of the circumference of the circular saw blade with a v-shaped hollow in the tooth back region;

FIG. 6 a plan view from the top of a circular saw blade to illustrate different axial angles;

FIG. 7 a section of a circular saw blade to illustrate a recess before a front face of a cutting edge;

FIG. 8 an embodiment of a saw blade with a specially configured contour before the front face of a cutting edge.

FIG. 1 shows a circular saw blade 1 having a saw blade body 2 on the circumference of which are provided cutting teeth 3 on which cutting edges 4 are arranged. The cutting edges 4 can be constructed from a comparatively hard material. In the region of the circumference the saw blade body 2 has a thickness reduction in a tooth-bearing region 5 or circumferential region. In particular, the saw blade body 2 can have a recess, hollow or indentation on one or on both sides. In the diagram shown the tooth-bearing region 5 is constructed in one section as a circular indentation 6. The width of the circular indentation 6, which can be provided on the side shown and also on the opposite side, is B. The width B is less than one third of the diameter of the circular saw blade 1.

In another region pocket-like recesses 7 are likewise provided in the tooth-bearing region, these being below the cutting, teeth 3. The tooth-bearing region 5 is a swarf space which, however, has no opening in the saw blade body 2. Any desired combinations of continuous, in particular circular, recesses 6 and pocket-like recesses 7 distributed over the boundary region or circumference and also on both sides of the circular saw blade 1 are conceivable. The tooth-bearing region 5 also does not have to have a constant thickness. The thickness of the tooth-bearing region 5 can vary. In particular, the tooth-bearing region 5 can narrow or thicken in the direction of the centre point 8. This can be achieved, for example, by different areas, in particular areas inclined with respect to a saw blade body centre plane, being provided in the tooth-bearing region 5. Expansion slots are identified by reference symbol 9.

It can be seen from FIG. 2 that in the region of the outer circumference the cutting tooth 3, in particular the back thereof, has a chamfer 10 or bevel. Below this is the tooth-bearing region 5 of reduced thickness. A chamfer 10 can also be constructed on the opposite side, so that an overall roof-like contour results.

An optional interruption 10.1 in this roof-like contour can be provided between the roof-like contour and the cutting edge 12. Alternatively, it is conceivable that an angled area of the cutting edge 12 passes without interruption directly into the roof-like contour formed from the chamfers 10 of the saw blade body 2.

In the section diagram of FIG. 3 it can be seen that in the circumferential region 5 the saw blade body 2 is reduced in its thickness D1 compared with the thickness D in the region which is not of reduced thickness. The depths T1, T2 of the recesses 6.1, 6.2 here are each less than one third of the thickness D of the saw blade body 2 in a region outside the circumferential region 5. The region of reduced thickness preferably has a thickness D1 of between 25% and 90% of the thickness D of the region which is not of reduced thickness.

It can furthermore be seen that the cutting edge 12 also has areas 13, 14 which are inclined to one another in roof-like manner. The cutting edge overhang 15 with respect to the saw blade body 2 in the region which is not of reduced thickness is more than 0 mm and up to 1.0 mm.

In the embodiment shown in FIG. 4a the saw blade body 2 has pockets 7 reduced in thickness which are not over the entire length of a cutting tooth 3 but merely in the region of a cutting edge 17. The pocket-like region of reduced thickness is thus directly below the cutting edge 17 and exclusively in this region. In the embodiment shown the tooth back 18 has a continuous straight-line contour.

In contrast, in the embodiment according to FIG. 4b the tooth back 19 has a u-shaped notch 16 which serves as a grinding or eroding tool discharge zone during circumferential working of the cutting edge 17. In this case also a pocket 7 is provided exclusively in the region of the cutting edge 17.

In the embodiment according to FIG. 4c the tooth back 20 likewise has a u-shaped notch 16 which serves as a grinding or eroding tool discharge zone during circumferential working of the cutting edge 17. The tooth back 20 here has two straight-line sections 20.1, 20.2 which, however, do not run parallel to one another. In contrast, the sections 19.1, 19.2 of the tooth back 19 run parallel to one another. In particular, the circumferential contour formed by the section 19.1 is continued in a straight line by the section 19.2. Both the sections 19.1, 19.2 and the sections 20.1, 20.1 could also be constructed as curved line parts. It is furthermore conceivable that only one of the sections 19.1, 19.2, 20.1, 20.2 is configured as a straight line and the other particular section of the tooth back 19, 20 is curved in configuration.

The embodiment according to FIG. 5 differs from the embodiment according to FIG. 4c in that instead of a u-shaped notch 16 a v-shaped notch 21 in the tooth back 22 is provided. The section 22.1 of the tooth back 22 runs here in a straight line. The section 22.2 also runs in a straight line, but at a different angle to the section 22.1. The sections 22.1, 22.2 accordingly do not run parallel. It can be seen in particular that the section 22.2, which is directly adjacent to the cutting edge 17, has a steeper angle than the section 22.1.

In the plan view of FIG. 6 it can be seen that the cutting edges 25.1 to 25.3 have front faces 23.1 to 23.3 which have different angles with respect to the saw blade centre plane and with respect to the direction of movement 24. In particular, the front faces 23.1, 23.2 are each inclined by an angle β1 and β2 respectively, which is also called the axial angle, the front faces 23.1, 23.2 being alternately inclined to the left or to the right. The front face 23.3, on the other hand, is not inclined. The alignment of the front faces 23.1 to 23.3 can be alternately to the left and to the right. It is furthermore conceivable that all the front faces 23.1 to 23.3 point to the left or all the front faces 23.1 to 23.3 point to the right. Any desired combinations and periodic repetitions of front faces 23.1 to 23.3 which are inclined to the left and right or also which are not inclined are also conceivable.

As shown in FIG. 7, directly below in front of the front face 23.4 of the cutting edge 17 a hollow 26 is provided, which serves as a feeding space for the swarf arising at the front face 23.4 into the lateral thickness reductions or pockets installed below the cutting edge 17. The hollow 26 can be semicircular, u-shaped or v-shaped in configuration.

In the embodiment according to FIG. 8, in front of the cutting edge 17 an ascending contour 28 is provided in front of a subsequent recess 29. Alternatively or in addition, behind a cutting edge 17 on the part lying in front in the direction of movement of the saw blade a u- or v-shaped notch 33 can be provided, which is followed by an ascending contour 29.2. The distance H between the highest elevation 30 of a cutting edge 17 and the highest elevation 31, 32 of the saw blade body 2 is preferably more than 0 mm and up to 1.1 mm.

The contours 28, 29.2 are a type of swarf directing stage. They serve to direct swarf of the preceding tooth away from the circumferential region into the lateral region of reduced thickness. They furthermore serve as an additional limitation in the swarf thickness according to the height H.

1. A saw blade (1) having a saw blade body (2) and a plurality of cutting teeth (3) distributed regularly or irregularly along a tooth-bearing region (5), in which a thickness of the saw blade body (2) below the cutting teeth (3) is reduced compared with a remainder of the saw blade body (2), and in which the saw blade body (2) has on one side or on both sides, at least in sections, a circular indentation (6),
wherein the tooth-bearing region (5) of reduced thickness serves as a swarf space; and
wherein the tooth-bearing region (5) of reduced thickness of the saw blade body (2) is provided with areas that are: inclined with respect to a saw blade center plane such that the tooth-bearing region (5) is configured with a thickness of the saw blade body (2) that increases towards a saw blade center, aligned parallel with respect to the saw blade center plane, or both.

2. (canceled)

3. A saw blade according to claim 1, wherein the saw blade body (2) has, at least in sections, below the cutting teeth (3) on one side or on both sides individual pockets (7), so that the saw blade body (2) has a lower thickness in the region of the pockets (7).

4. A saw blade according to claim 1, wherein a width (B) of the tooth-bearing region (5) of reduced thickness is up to one third of the saw blade diameter.

5. A saw blade according to claim 1, wherein the thickness of the saw blade body in the tooth-bearing region (5) is greater than one third of the thickness of the saw blade body (2) outside the tooth-bearing region (5).

6. (canceled)

7. (canceled)

8. A saw blade according to claim 1, wherein areas on opposite sides with respect to a saw blade center plane are configured asymmetrically with respect to the saw blade center plane.

9. A saw blade according to claim 1, wherein chamfers or bevels (10) are provided on the circumference or boundary of the saw blade (1).

10. A saw blade according to claim 9, wherein the chamfers or bevels (10) extend in continuous line or area courses into the saw blade body (2).

11. A saw blade according to claim 9, wherein the chamfers or bevels (10) extend into the region which is not of reduced thickness.

12. A saw blade according to claim 1, where a chamfer or bevel (10) is provided on the outer circumference or boundary of the saw blade (1) that extends to behind a cutting edge (12) of the next cutting tooth (3).

13. A saw blade according to claim 1, wherein cutting edges (4, 12) are arranged on the cutting teeth, and a lateral cutting edge overhang (15) between 0 and 1.0 mm with respect to the saw blade body which is not reduced in thickness.

14. A saw blade according to claim 1, wherein an outer circumference or the boundary of the saw blade (1) has a notch (16, 21), which is u-shaped or v-shaped.

15. A saw blade according to claim 13, wherein front faces (23.1-23.3) of the cutting teeth (3) or of the cutting edges have an axial angle β in the range of 0<β<45°.

16. A saw blade according to claim 1, wherein the saw blade body (2) has a hollow (26) directly before at least one cutting tooth (3) or at least one cutting edge (4, 12, 17).
